(19) United States
(12) Patent Application Publication
(10) Pub. No.: US 2025/0061909 A1
(43) Pub. Date: Feb. 20, 2025

(54) SPEECH SIGNAL PROCESSING METHOD, SPEECH SIGNAL PROCESSING APPARATUS, AND PROGRAM

(71) Applicant: NIPPON TELEGRAPH AND TELEPHONE CORPORATION, Tokyo (JP)

(72) Inventors: Hiroshi SATO, Tokyo (JP); Tsubasa OCHIAI, Tokyo (JP); Marc DELCROIX, Tokyo (JP); Keisuke KINOSHITA, Tokyo (JP); Naoyuki KAMO, Tokyo (JP); Takafumi MORIYA, Tokyo (JP)

(73) Assignee: NIPPON TELEGRAPH AND TELEPHONE CORPORATION, Tokyo (JP)

(21) Appl. No.: 18/717,386

(22) PCT Filed: Dec. 10, 2021
(86) PCT No.: PCT/JP2021/045610

§ 371 Date: Jun. 6, 2024

(51) Int. Cl. G10L 21/0208

(52) U.S. Cl. CPC G10L 21/0208

(57) ABSTRACT

Voice recognition performance is improved. A voice signal processing method according to an embodiment of the present invention acquires an output value indicating whether to perform voice enhancement on an observation signal in which a voice or noise of another speaker overlaps a voice of a target speaker, or a degree of necessity of performing the voice enhancement. The ratio between the observation signal and the enhancement signal generated by the voice enhancement is decided under a predetermined condition using the acquired output value, and the input signal used for the voice recognition is determined.

### TECHNICAL FIELD

The present invention relates to a voice recognition technology, and particularly relates to a switching technology between an enhancement signal and an observation signal.

### BACKGROUND ART

In recent years, the performance of voice recognition has been improved by the development of deep learning technology. However, an example of a situation in which voice recognition is still difficult is mixed voice (overlapping speech) of a plurality of persons. In order to cope with this, the following techniques have been devised.

The blind sound source separation enables voice recognition by separating a voice as a mixed voice that is difficult to recognize into speakers' respective voices (see, for example, Non Patent Literature 1).

The target speaker extraction uses a speech preregistered by a target speaker as auxiliary information, and acquires only a voice of the preregistered speaker from a mixed sound (for example, see Non Patent Literature 2). The extracted voice includes only the voice of the target speaker, and thus voice recognition is possible. However, when the undesirable sounds are removed, the voice of the target speaker may be distorted. That is, there is a case where voice recognition performance is deteriorated by performing voice enhancement.

A method of weakening the intensity of voice enhancement for a section in which an overlap speech does not occur has been proposed (see, for example, Non Patent Literature 3). Although the voice enhancement is effective for the overlap speech, there is a high possibility that the voice recognition is deteriorated when the voice enhancement is performed on the non-overlap speech (the independent speech of the target speaker).

### CITATION LIST

### Non Patent Literature

Non Patent Literature 1: Yu, Dong, et al. “Permutation invariant training of deep models for speaker-independent multi-talker speech separation.” 2017 IEEE International Conference on Acoustics, Speech and Signal Processing (ICASSP). IEEE, 2017.
Non Patent Literature 2: Zmolikova, Katerina, et al. “SpeakerBeam: Speaker aware neural network for target speaker extraction in speech mixtures.” IEEE Journal of Selected Topics in Signal Processing 13.4 (2019): 800-814. Non Patent Literature 3: Wang, Quan, et al. “VoiceFilter-Lite: Streaming Targeted Voice Separation for On-Device Speech Recognition.” arXiv preprint arXiv: 2009. 04323 (2020).

### SUMMARY OF INVENTION

### Technical Problem

However, the effect of the voice enhancement is not determined only by the presence or absence of the overlap speech. For example, even in the overlap speech section, if there is a large difference in volume between the volume of the target speaker and the interference speaker, which is another speaker, voice recognition tends to recognize only the voice of the target speaker with a large volume. In this case, it is considered that a high voice recognition rate can be obtained as a result by performing voice recognition on the observation signal as it is without performing voice enhancement. Similarly, it is also conceivable that a result of a higher voice recognition rate can be obtained in the input to which voice enhancement is applied even in the section of the non-overlap speech. In view of the above problems, an object of the present invention is to provide a technology capable of improving voice recognition performance.

### Solution to Problem

In order to solve the problem described above, a voice signal processing method according to an aspect of the present invention includes: acquiring an output value indicating whether to perform voice enhancement on an observation signal in which a voice or noise of another speaker overlaps with a voice of a target speaker, or indicating a degree of necessity of performing the voice enhancement; and deciding, under a predetermined condition, a ratio between the observation signal and an enhancement signal generated by the voice enhancement using the acquired output value to determine an input signal to be used for the voice recognition.

### Advantageous Effects of Invention

According to the present invention, voice recognition performance can be improved.

### BRIEF DESCRIPTION OF DRAWINGS

FIG. 1 is a diagram illustrating a functional configuration example of a voice signal processing device according to an embodiment of the present invention.

FIG. 2 is a diagram illustrating an example of a processing flow of a voice signal processing method in the voice signal processing device according to the embodiment of the present invention.

FIG. 3 is a diagram illustrating an exemplary functional configuration of a voice recognition input determination unit 13.

FIG. 4 is a diagram illustrating an example of a processing flow of a method for determining a voice recognition input in the voice recognition input determination unit 13.

FIG. 5 is a diagram illustrating a functional configuration example of a switching model learning device.

FIG. 6 is a diagram illustrating a processing flow example of a method of creating a learned model in the switching model learning device.

FIG. 7 is a diagram illustrating a functional configuration example of a switching label creation device.

FIG. 8 is a diagram illustrating a processing flow example of a method of creating a switching label in the switching label creation device.

FIG. 9 is a diagram illustrating an example of a performance result of voice recognition using a voice signal processing device 1.

FIG. 10 is a diagram illustrating a functional configuration of a computer.

### DESCRIPTION OF EMBODIMENTS

First, a notation method in this specification will be described.

### <Notation Method>

The symbol “\hat{ }” (superscripted tilde) used in the text would normally be written immediately above the immediately following character, but is written immediately before the character due to limitations of text notation. In a mathematical formula, these symbols are placed in the rightful positions, that is, directly above the characters. For example, “˜S” is expressed by the following expression in the mathematical expression.

$$\tilde{S} \qquad [ Math . 1 ]$$

In addition, a symbol “\hat{ }” (superscripted hat) used in this specification is also described immediately before the character. In a mathematical formula, these symbols are placed in the rightful positions, that is, directly above the characters. For example, “\hat{ }k” is expressed by the following expression in the mathematical expression.

$$\hat{k} \qquad [ Math . 2 ]$$

Hereinafter, an embodiment of the present invention will be described in detail. Constituents that have the same functions are denoted by the same reference numerals, and redundant description will be omitted.

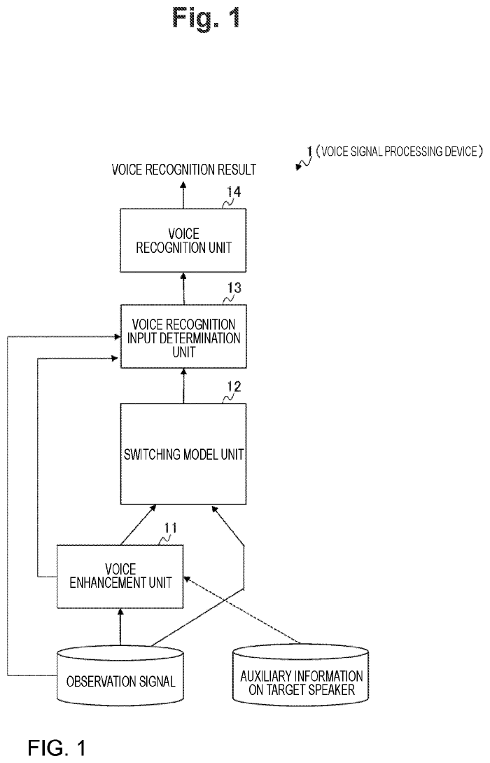

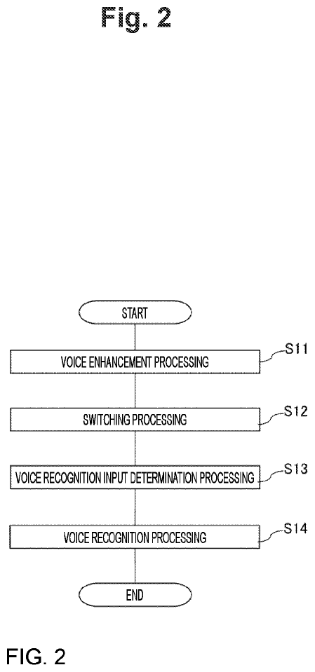

FIG. 1 illustrates a functional configuration example of a voice signal processing device according to an embodiment of the present invention. The voice signal processing device 1 illustrated in FIG. 1 includes a voice enhancement unit 11, a switching model unit 12, a voice recognition input determination unit 13, and a voice recognition unit 14. The voice signal processing device 1 performs the processing of each step illustrated in FIG. 2, thereby achieving a voice signal processing method of the embodiment. In an aspect of the voice signal processing device 1, one of the observation signal and the enhancement signal that is used as the input of the voice recognition is switched using the output result of the learned switching model unit 12 as described later. As a result, the voice recognition performance can be improved as compared with a case where voice recognition is performed after voice enhancement is always performed or a case where observation signals are always recognized.

Hereinafter, the voice signal processing method performed by the voice signal processing device 1 according to the embodiment will be described with reference to FIG. 2.

In step S11, the voice enhancement unit 11 performs voice enhancement processing. That is, the voice enhancement unit 11 acquires an observation signal as an input, extracts only desired voice from the acquired observation signal using a known voice enhancement technology, and performs voice enhancement processing. As a method for extracting a desired voice, for example, a known target speaker extraction technology can be used. As illustrated in FIG. 1, the target speaker extraction technology is a technology in which the voice enhancement unit 11 extracts only the voice of the target speaker from the observation signal by acquiring auxiliary information related to the target speaker in addition to acquiring the observation signal. As the auxiliary information related to the target speaker, for example, a speech registered in advance by the target speaker or the like can be used. As the input signal acquired by the voice enhancement unit 11, a voice waveform itself obtained from the observation signal can be used, or a feature amount or the like extracted from the observation signal can be used. The voice enhancement unit 11 outputs the voice signal (hereinafter, also referred to as an “enhancement signal”) subjected to the voice enhancement processing to the switching model unit 12.

In step S12, the switching model unit 12 receives the enhancement signal from the voice enhancement unit 11. The switching model unit 12 also receives an observation signal that is a voice signal that has not been subjected to the voice enhancement processing of the voice enhancement unit 11. The observation signal is configured to be directly input to the switching model unit 12 as illustrated in FIG. 1, similarly to the input to the voice enhancement unit 11. Since the voice enhancement unit 11 acquires the observation signal in step S11, the observation signal on which the voice enhancement processing is not performed may be output from the voice enhancement unit 11 to the switching model unit 12.

The switching model unit 12 is a learned model learned using a technology such as a known deep neural network. The signal received as an input by the switching model unit 12 can be a signal of a waveform region. It also can be a signal that has been subjected to feature extraction. At least one of the observation signal and the enhancement signal is input to the switching model unit 12, and the switching model unit 12 outputs whether to perform the voice enhancement from the viewpoint of the voice recognition performance or the degree of necessity of performing the voice enhancement. \hat{ }k, which is the output of the switching model unit 12, is a value (estimated value) calculated by the switching model unit 12, and can be, for example, a scalar value in a range of 0 to 1 defined by the following expression.

$$\hat{k} ∈ [ 0 , 1 ] \qquad [ Math . 3 ]$$

The switching model unit 12 may be configured to calculate \hat{ }k as an output as a time-series vector. Since \hat{ }k that is the output is calculated as a time-series vector, it is possible to adopt different weights for each time, and it is possible to more finely determine the input of the voice recognition.

The switching model unit 12 outputs \hat{ }k, which is the calculated result, to the voice recognition input determination unit 13. A learning method of the switching model unit 12 will be described later.

In step S13, the voice recognition input determination unit 13 receives the output value \hat{ }k received from the switching model unit 12 and \hat{ }S from the voice enhancement unit 11, and determines the input of the voice recognition.

Here, when the input to the voice recognition unit 14 is set as ˜S, the input ˜S to the voice recognition unit 14 is determined as either the enhancement signal \hat{ }S or the observation signal Y as defined by the following expression. In Expression (2), λ is a preset value in a range of 0<λ<1, such as 0.5. In the present embodiment, a method of determining one of the enhancement signal \hat{ }S and the observation signal Y as ˜S that is an input to the voice recognition unit 14 in this manner will be referred to as a “hard method”.

$$\begin{matrix}[ Math . 4 ] & \\ \hat{k} ∈ [ 0 , 1 ] , & ( 1 )\end{matrix}$$

$$\begin{matrix}[ Math . 5 ] & \\ \tilde{S} = \{ \begin{matrix}\hat{S} ( \hat{k} > λ ) \\ Y ( \hat{k} \leq λ ) )\end{matrix} & ( 2 )\end{matrix}$$

˜S, which is the input of the voice recognition, may be determined by weighting and adding the enhancement signal \hat{ }S and the observation signal Y using the output value \hat{ }k of the switching model unit 12 as defined by the following expression. In the present embodiment, a method of determining ˜S which is an input to the voice recognition unit 14 by weighting and adding the enhancement signal \hat{ }S and the observation signal Y using the output value \hat{ }k will be referred to as a “soft method”.

$$\begin{matrix}[ Math . 6 ] & \\ \tilde{S} = \hat{k} \cdot \hat{S} + ( 1 - \hat{k} ) \cdot Y & ( 3 )\end{matrix}$$

The voice recognition input determination unit 13 outputs ˜S determined by the hard method or the soft method to the voice recognition unit 14.

In step S14, the voice recognition unit 14 performs voice recognition processing on the signals ˜S received from the voice recognition input determination unit 13. The voice recognition unit 14 may receive the enhancement signal \hat{ }S obtained by the voice enhancement unit 11 and the observation signal Y including speech, noise, or the like of another speaker, and perform voice recognition processing on each of them. The voice recognition unit 14 outputs text information that is a voice recognition result corresponding to each voice signal. A known voice recognition technology can be used as the voice recognition unit 14.

### <Processing of Voice Recognition Input Determination Unit 13>

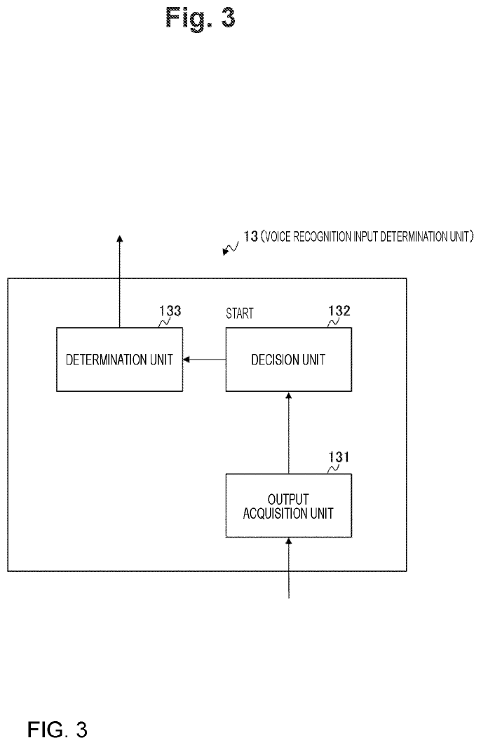

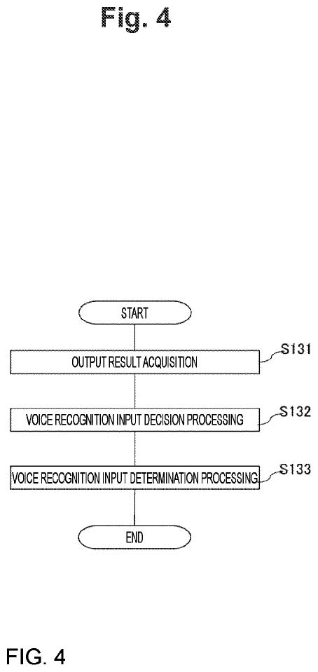

A specific processing flow of the voice recognition input determination processing (FIG. 2, step S13) in the voice recognition input determination unit 13 according to the embodiment of the present invention will be described. FIG. 3 is a diagram illustrating an exemplary functional configuration of the voice recognition input determination unit 13. The voice recognition input determination unit 13 includes an output acquisition unit 131, a decision unit 132, and a determination unit 133. The voice recognition input determination unit 13 determines the input of the voice recognition by performing the processing of each step exemplified in FIG. 4. A method for determining the voice recognition input performed by the voice recognition input determination unit 13 will be described below with reference to FIG. 4.

In step S131, the output acquisition unit 131 receives the output value \hat{ }k from the switching model unit 12. The output acquisition unit 131 transmits the received output value \hat{ }k to the decision unit 132. In step S132, the decision unit 132 performs predetermined decision using the received output value \hat{ }k, and outputs a decision result to the determination unit 133. In the predetermined decision, for example, in a case where a hard method is adopted, the magnitude of \hat{ }k is determined, and only one signal of \hat{ }S or Y is output to the determination unit 133 by the decision using the above expressions (1) and (2). When the soft method is adopted, signals of \hat{ }S and Y are output to the determination unit 133 in addition to the value of \hat{ }k. As another example, information indicating one of the soft method and the hard method that is to be adopted, a value of \hat{ }k, and signals of \hat{ }S and Y may be output to the determination unit 133. In step S133, the determination unit 133 determines the input signal ˜S by using the information received from the decision unit 132 and Expressions (1) to (3) described above.

### <Learning Method of Switching Model>

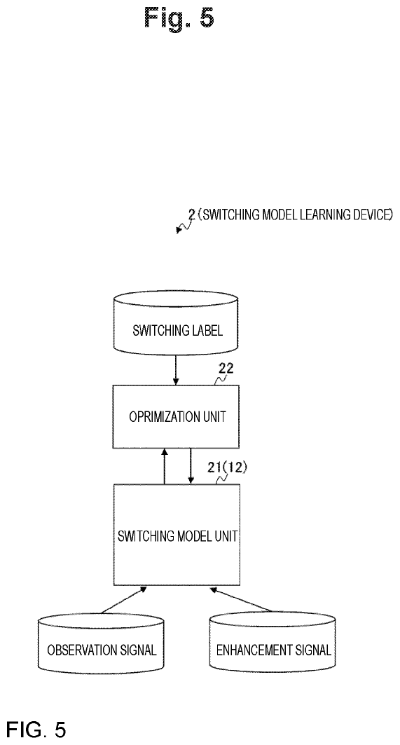

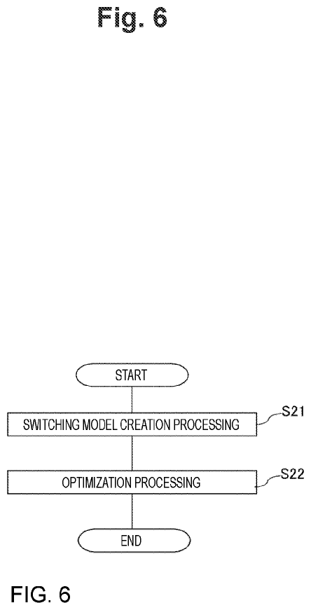

The learning method of the switching model unit 12 in the embodiment of the present invention is performed using the switching model learning device illustrated in FIG. 5. The switching model learning device 2 includes a switching model unit 21 and an optimization unit 22. The switching model learning device 2 performs learning by performing optimization processing on the model created by the switching model unit 21 by the optimization unit 22. The switching model unit 21 is used as the switching model unit 12 as a learned model used in the voice signal processing device 1 by learning by the switching model learning device 2. The switching model learning device 2 performs the processing of each step illustrated in FIG. 6, thereby achieving the learning processing of the switching model. A switching model learning method according to the embodiment will be described below with reference to FIG. 6.

In step S21, the switching model unit 21 receives the observation signal and the enhancement signal for learning, a basic configuration of the switching model is constructed, and this model (switching model being learned) is output to the optimization unit 22.

In step S22, the optimization unit 22 receives the model received from the switching model unit 21 and the switching label created by the switching label creation device 3 to be described later, optimizes parameters of the model, and returns the parameters to the switching model unit 21. Processing between model construction by the switching model unit 21 and parameter optimization by the optimization unit 22 may be configured to complete the optimization by repeating these processing by loop processing. In any case, when the optimization is completed and the parameter is determined, the content is reflected in the switching model unit 21, and the switching model is completed.

A specific method of optimization by the optimization unit 22 is as follows. The optimization unit 22 calculates a loss function between the switching label k generated by the switching label creation device 3 to be described later and the output value \hat{ }k calculated by the switching model unit 21, and optimizes the model parameters included in the switching model unit 21 by minimizing the loss function.

As the loss function, for example, a known cross entropy loss defined by the following expression can be used.

$$L = - ( k log ( \hat{k} ) + ( 1 - k ) log ( 1 - \hat{k} ) ) \qquad [ Math . 7 ]$$

Here, the switching model unit 21 (and the switching model unit 12) may adopt a function of simultaneously estimating the SIR and the SNR of the observation signal, in addition to the calculation of \hat{ }k, in order to improve the identification performance of the voice recognition of the voice recognition unit 14. The SIR is an abbreviation of a signal to interference ratio, and is a true value of a ratio between a voice of a target speaker and a voice of another speaker. The SNR is an abbreviation of a signal to noise ratio, and is a true value of a ratio between voice and noise of a target speaker. Since the SIR indicates the ratio between the target speaker signal and the interference speaker signal, it is deeply related to the effect of voice enhancement. In addition, the SNR is closely related to the effect of voice enhancement because non-voice noise has a small adverse effect on voice recognition, but it is relatively difficult to remove the non-voice noise by voice enhancement.

Estimates of the SIR and the SNR of the observation signal by the switching model unit 21 are defined as \hat{ }SIR and \hat{ }SNR, respectively. That is, \hat{ }SIR is an output value of the switching model unit 21 when the SIR is input as an observation signal, and \hat{ }SNR is an output value of the switching model unit 21 when the SNR is input as an observation signal. When the voice of the target speaker is S, the voice of the interference speaker is I, and noise is N, the SIR and the SNR are defined by the following expressions.

$$SIR = 10 {log}_{10} \frac{{‖ S ‖}^{2}}{{‖ I ‖}^{2}} , \qquad [ Math . 8 ]$$

$$SNR = 10 {log}_{10} \frac{{‖ S ‖}^{2}}{{‖ N ‖}^{2}} \qquad [ Math . 9 ]$$

When the SIR and the SNR of the observation signal are simultaneously estimated, the switching model unit 21 performs learning (hereinafter, also referred to as “multi-task learning”) to minimize a loss function obtained by weighting and adding a loss function related to an estimation error of the SIR and the SNR and the loss function for the switching label k. For example, the loss function of the SIR and the SNR estimation can use a square error as defined by the following expression.

$${L}_{SIR} = {( - SIR )}^{2} , \qquad [ Math . 10 ]$$

$${L}_{SNR} = {( - SNR )}^{2} \qquad [ Math . 11 ]$$

Here, the loss function Lₘᵤₗₜᵢ due to multitasking is defined by the following expression using the parameters α and β.

$$[ Math . 12 ]$$

$${L}_{multi} = L + α {L}_{SIR} + β {L}_{SNR}$$

The learning method of the switching model unit 21 has been described above by the processing of the switching model unit 21 and the optimization unit 22. The completed switching model unit 21 is used as the switching model unit 12 in the voice signal processing device 1.

### <Method of Creating Switching Label>

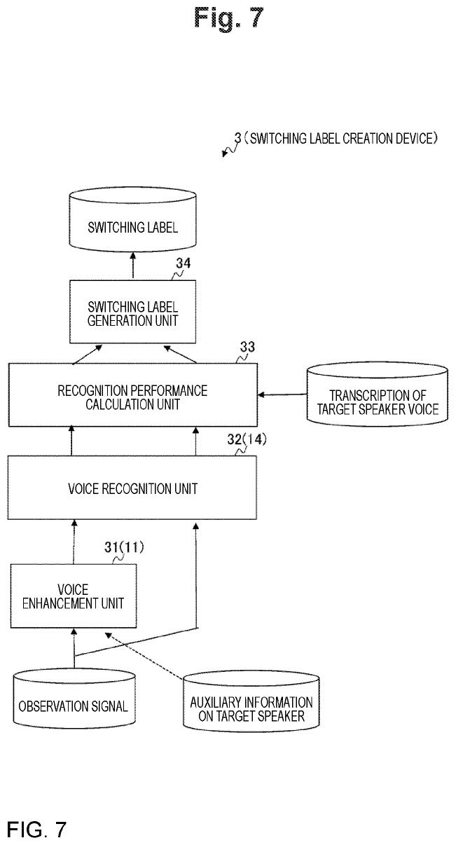

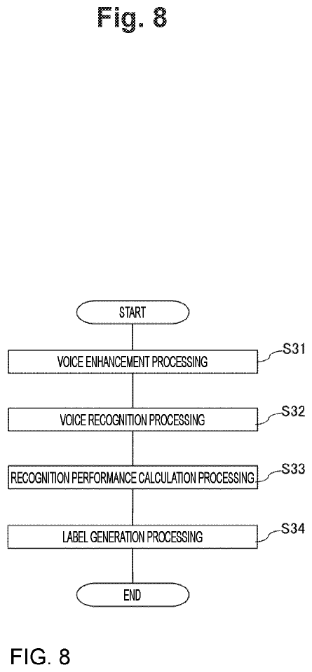

The method of creating a switching label in the embodiment of the present invention is performed using the switching label creation device illustrated in FIG. 7. The switching label creation device 3 includes a learned voice enhancement unit 31, a learned voice recognition unit 32, a recognition performance calculation unit 33, and a switching label generation unit 34. The voice enhancement unit 31 has the same function as the voice enhancement unit 11 in FIG. 1. The voice recognition unit 32 has the same function as the voice recognition unit 14 in FIG. 1. The switching label creation device 3 generates a switching label by using pair data of an observation signal, auxiliary information on a target speaker, and a transcription of a voice of the target speaker. The switching label creation device 3 performs the processing of each step illustrated in FIG. 8, thereby achieving the switching label creation method of the embodiment. A method of creating a matching label used in the switching model learning device 2 will be described below with reference to FIG. 8.

In step S31, the voice enhancement unit 31 performs voice enhancement processing. That is, the voice enhancement unit 31 acquires an observation signal as an input, extracts only desired voice from the acquired observation signal using a known voice enhancement technology, and performs voice enhancement processing. At this time, as the auxiliary information related to the target speaker, for example, a speech registered in advance by the target speaker or the like can be used. The voice enhancement unit 31 outputs the enhancement signal subjected to the voice enhancement processing to the voice recognition unit 32.

In step S32, the voice recognition unit 32 receives an observation signal including a voice, noise, or the like of another speaker in addition to the enhancement signal obtained from the voice enhancement unit 31. By performing voice recognition processing on each of the received observation signals, text information that is a voice recognition result corresponding to each voice signal is output to the recognition performance calculation unit 33.

In step S33, the recognition performance calculation unit 33 receives a transcription of the target speaker's voice in addition to the voice recognition result corresponding to the enhancement signal received from the voice recognition unit 32 and the voice recognition result for the observation signal. The transcription of the voice of the target speaker corresponds to correct information of a voice signal to be subjected to voice recognition. The recognition performance calculation unit 33 calculates the performance of voice recognition using the two voice recognition results and the transcription. As a method of calculating the voice recognition performance, a known voice recognition performance evaluation criterion such as a character error rate can be used. The recognition performance calculation unit 33 outputs the calculated performance result of voice recognition to the switching label generation unit 34.

In step S34, the switching label generation unit 34 generates a switching label k used as a training label by the optimization unit 22 illustrated in FIG. 5 for the optimization of the switching model unit 21, on the basis of the voice recognition performance for the enhancement signal and the voice recognition performance for the observation signal acquired from the recognition performance calculation unit 33. The switching label k is a label indicating one of the observation signal and the enhancement signal that has higher voice recognition performance, and is defined by, for example, the following expression.

$$[ Math . 13 ]$$

$$k = \{ \begin{matrix}0 & ( C E {R}_{obs} < C E {R}_{enh} ) \\ 1 & ( otherwise )\end{matrix} \qquad ( 4 )$$

Here, CER_{obs} indicates voice recognition performance based on the character error rate of the observation signal, and CERₑₙₕ indicates voice recognition performance based on the character error rate of the enhancement signal. In the case of the switching label k expressed by Expression (4) described above, when the character error rate of CER_{obs}, which is the voice recognition performance of the observation signal, is lower than that of CERₑₙₕ, which is the voice recognition performance of the enhancement signal (in other words, when CER_{obs} has better voice recognition performance), the switching label k is set to 0 (zero). When the character error rate of CERₑₙₕ, which is the voice recognition performance of the enhancement signal, is lower than that of CER_{obs}, which is the voice recognition performance of the observation signal (in other words, when CERₑₙₕ has better voice recognition performance), the switching label k is set to 1 (one). That is, the switching label k is a binary label of 0 or 1.

The switching label k may not be a binary label but may be determined more flexibly as follows. That is, the voice recognition performance of each of the observation signal and the enhancement signal may be compared and calculated on the basis of the performance difference. For example, T may be a temperature parameter, and the switching label k may be more flexibly determined than the binary label by using a definition formula of the following formula.

$$[ Math . 14 ]$$

$$k = \frac{exp ( C E {R}_{obs} / T )}{exp ( C E {R}_{obs} / T ) + exp ( C E {R}_{enh} / T )}$$

A method of determining the switching label k may be as follows. That is, a weight may be used that maximizes the voice recognition performance when the voice obtained by weighting and averaging the observation signal and the enhancement signal is recognized. As one method for achieving this, the voice recognition unit 32 may obtain a recognition result for the voice in which the observation signal and the enhancement signal are weighted and added at various ratios, the recognition performance calculation unit 33 may calculate the recognition performance for each of them, and the switching label generation unit 34 may use the weight that has achieved the highest recognition performance as the switching label k.

Through the above processing, pair data for four types of information including an observation signal, auxiliary information related to a target speaker, an enhancement signal, and a switching label is generated.

### <Regarding Performance Results>

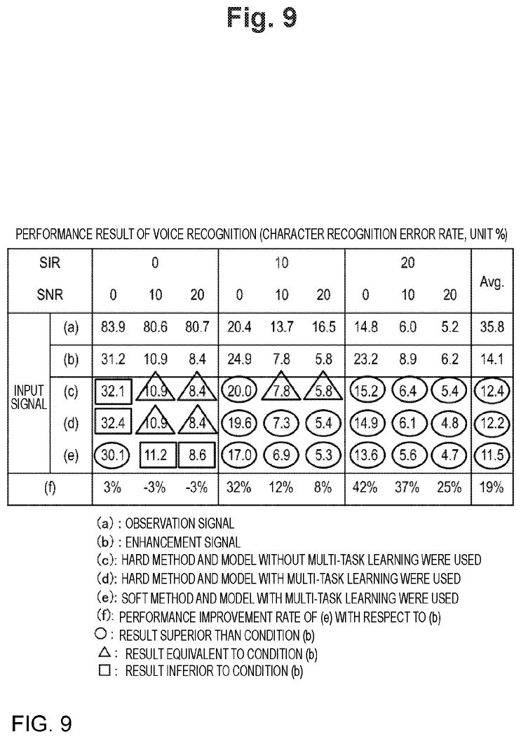

FIG. 9 is a diagram illustrating an example of a performance result of voice recognition using the voice signal processing device 1. FIG. 9 illustrates results in five cases of condition (a) to condition (e) as input targets to voice recognition unit 14. Here, the condition (a) represents the observation signal, the condition (b) represents the enhancement signal, the condition (c) represents a case where the hard method of the present embodiment and the model without multi-task learning are used, the condition (d) represents a case where the hard method of the present embodiment and the model with multi-task learning are used, and the condition (e) represents a case where the soft method of the present embodiment and the model with multi-task learning are used. In FIG. 9, the SIR and the SNR are evaluated in three stages for each of the conditions (a) to (e). That is, FIG. 9 illustrates a result in a case where the voice recognition processing is performed while the SIR is changed in three stages of 0, 10, and 20 and the SNR is changed in three stages of 0, 10, and 20. The performance results of voice recognition under the respective conditions are shown using a character error rate reference except for the condition (f), and the smaller the number, the higher the performance of voice recognition. In FIG. 9, since the same voice recognition unit is used to perform voice recognition, it is possible to directly compare the character recognition results of the respective conditions. FIG. 9(f) illustrates the performance improvement rate with respect to the result of the condition (b) in the result of the condition (e). In FIG. 9, in the results of the condition (c) to the condition (e), as compared with the result of the condition (b), a result that is superior to the performance result of the condition (b) is enclosed by a circle “o”, a result that is equivalent to the performance result of the condition (b) is enclosed by a triangle “A”, and a result that is inferior to the performance result of the condition (b) is enclosed by a square “D”.

As illustrated in FIG. 9, when the hard method of the condition (c) and the model without multi-task learning in the present embodiment were used, only the case where SIR=0 and SNR=0 was inferior to the enhancement signal of the condition (b), four cases where SIR=0 and 10 and SNR=10 and 20 were equivalent to the enhancement signal of the condition (b), and the remaining four cases were performance results superior to the enhancement signal of the condition (b). The performance of the average value (Avg.) was 1.7% superior to the performance of the enhancement signal of the condition (b).

When the hard method of the condition (d) and the model with multi-task learning in the present embodiment were used, only the case where SIR=0 and SNR=0 was inferior to the enhancement signal of the condition (b), two cases where SIR=0 and SNR=10 and 20 were equivalent to the enhancement signal of the condition (b), and the remaining six cases were results superior to the enhancement signal of the condition (b). The result of the average value was 1.9% superior to the result of the enhancement signal of the condition (b).

When the soft method of the condition (e) and the model with multi-task learning in the present embodiment were used, two cases where SIR=0 and SNR=10, 20 were inferior to the enhancement signal of the condition (b), no case was equivalent to the enhancement signal of the condition (b), and the remaining seven cases were results superior to the enhancement signal of the condition (b). The performance result of the average value was 2.6% superior to the performance result of the enhancement signal of the condition (b).

Regarding the performance improvement rate of the condition (e) with respect to the result of the condition (b) illustrated in FIG. 9(f), although a performance degradation of 3% was observed in both cases where SIR=0 and SNR was 10 and 20, the other seven cases had better performance results than the condition (b). Specifically, an improvement of 8% to 32% is observed when the SIR is 10, and an improvement of 25% to 42% is observed when the SIR is 20. The overall average value also showed an improvement in the recognition rate of 198. As described above, it can be seen that the performance of voice recognition is improved when voice recognition input determination unit 13 of the present embodiment is used, as compared with the performance of voice recognition using an enhancement signal.

The voice signal processing method according to the embodiment of the present invention has been described above. By using the method of the present embodiment, in the present invention, by using \hat{ }k output from the switching model unit 12, it is possible to prevent performance deterioration due to voice enhancement by selectively using an enhancement signal and an observation signal, and to improve voice recognition performance. As a result, it is possible to appropriately determine the presence or absence of the voice enhancement in a case where the voice enhancement is not necessary even in the section in which the overlap speech occurs or in a case where the voice enhancement is necessary even in the section in which the overlap speech does not occur. As a result, the enhancement signal and the observation signal can be appropriately switched, and as a result, the voice recognition performance can be improved.

In addition, in the model with multi-task learning for estimating the SIR and the SNR described in the present embodiment, higher identification performance can be obtained by considering the SIR and the SNR deeply related to voice enhancement.

Furthermore, by weighting and adding the enhancement signal and the observation signal using \hat{ }k that is the output of the switching model unit 12, it is possible to determine the input voice in consideration of the uncertainty of the identification model.

Various kinds of processing described above may be executed not only in time series in accordance with the description but also in parallel or individually in accordance with processing abilities of the devices that execute the processing or as necessary. In addition to the above, it is needless to say that appropriate modifications can be made without departing from the scope of the present invention.

### [Program and Recording Medium]

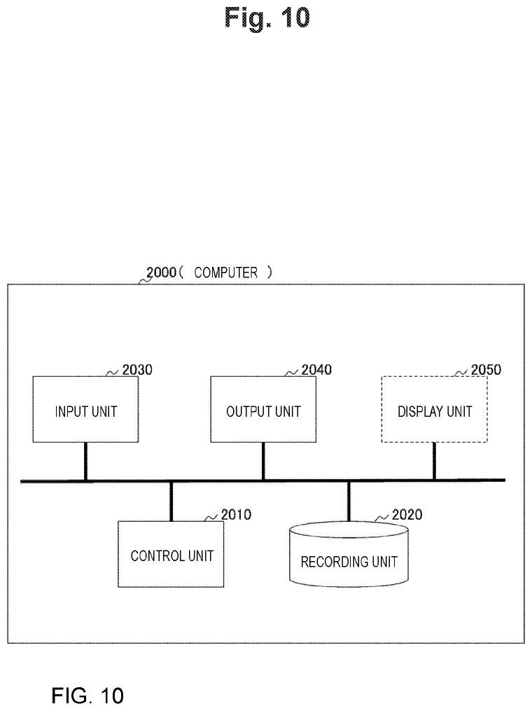

The various kinds of processing described above can be performed by causing a recording unit 2020 of a computer 2000 illustrated in FIG. 10 to read a program for executing each step of the method described above and causing a control unit 2010, an input unit 2030, an output unit 2040, a display unit 2050, and the like to operate.

The program in which the processing content is written may be recorded on a computer-readable recording medium. The computer-readable recording medium may be, for example, any recording medium such as a magnetic recording device, an optical disk, a magneto-optical recording medium, or a semiconductor memory.

In addition, the program is distributed by, for example, selling, transferring, or renting a portable recording medium such as a DVD or a CD-ROM on which the program is recorded. Further, a configuration may also be employed in which the program is stored in a storage device of a server computer and the program is distributed by transferring the program from the server computer to other computers via a network.

For example, a computer that executes such a program first temporarily stores a program recorded on a portable recording medium or a program transferred from the server computer in a storage device of the computer. Then, when executing processing, the computer reads the program stored in the recording medium of the computer and executes the processing according to the read program. In addition, as another mode of the program, the computer may read the program directly from the portable recording medium and execute processing according to the program, or alternatively, the computer may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program in this mode includes information that is to be used in the process by an electronic computer, and is equivalent to the program (data and the like that are not direct commands to the computer but have properties that define the processing to be performed by the computer).

In addition, although the present devices are each configured by executing a predetermined program on a computer in the present embodiments, at least part of the processing content may be implemented by hardware.

### REFERENCE SIGNS LIST

1 Voice signal processing device
11, 31 Voice enhancement unit
12, 21 Switching model unit
13 Voice recognition input determination unit
14, 32 Voice recognition unit
2 Switching label creation device
3 Switching model learning device
22 Optimisation unit
33 Recognition performance calculation unit
34 Switching label generation unit
131 Output acquisition unit
130 Decision unit
133 Determination unit

1. A voice signal processing method comprising:
acquiring an output value indicating whether to perform voice enhancement on an observation signal in which a voice or noise of another speaker overlaps with a voice of a target speaker, or indicating a degree of necessity of performing the voice enhancement; and
deciding, under a predetermined condition, a ratio between the observation signal and an enhancement signal generated by the voice enhancement using the output value that has been acquired, to determine an input signal to be used for voice recognition.

2. The voice signal processing method according to claim 1, wherein the predetermined condition is defined by the following expression when the output value is \hat{ }k, the enhancement signal is \hat{ }S, the observation signal is Y, the input signal is ˜S, and λ is a preset value in a range of 0<λ<1.
$$[ Math . 15 ]$$
$$\hat{k} ∈ [ 0 , 1 ] ,$$
$$[ Math . 16 ]$$
$$\tilde{S} = \{ \begin{matrix}\hat{S} & ( \hat{k} > λ ) \\ Y & ( \hat{k} \leq λ )\end{matrix}$$

3. The voice signal processing method according to claim 1, wherein the predetermined condition is defined by the following expression when the output value is \hat{ }k, the enhancement signal is \hat{ }S, the observation signal is Y, and the input signal is ˜S.
$$[ Math . 17 ]$$
$$\tilde{S} = \hat{k} \cdot \hat{S} + ( 1 - \hat{k} ) \cdot Y$$

4. The voice signal processing method according to claim 1, wherein the output value is an output value output by a learned model, and the learned model receives, as an input, at least one of the observation signal and the enhancement signal, and outputs whether to perform the voice enhancement from a viewpoint of voice recognition performance or the degree of necessity of performing the voice enhancement.

5. The voice signal processing method according to claim 4, wherein the learned model is learned to minimize L, which is a calculation result defined by the following expression, when a loss coefficient is L and a training label used to generate the learned model is k.
$$[ Math . 18 ]$$
$$L = - ( k log ( \hat{k} ) + ( 1 - k ) log ( 1 - \hat{k} ) )$$

6. The voice signal processing method according to claim 5, wherein, in the observation signal, when a true value of a ratio between the voice of the target speaker and the voice of the another speaker is SIR, a true value of a ratio between the voice of the target speaker and the noise is SNR, an output value of the learned model when the SIR is input is \hat{ }SIR, and an output value of the learned model when the SNR is input is \hat{ }SNR, Lₘᵤₗₜᵢ that is a calculation result defined by the following expression is used as the loss coefficient by using parameters α and β.
$$[ Math . 19 ]$$
$${L}_{SIR} = {( - SIR )}^{2} ,$$
$$[ Math . 20 ]$$
$${L}_{SNR} = {( - S N R )}^{2}$$
$$[ Math . 21 ]$$
$${L}_{multi} = L + α {L}_{SIR} + β {L}_{SNR}$$

7. A voice signal processing device comprising:
an acquisition unit that acquires an output value indicating whether to perform voice enhancement on an observation signal in which a voice or noise of another speaker overlaps with a voice of a target speaker, or indicating a degree of necessity of performing the voice enhancement; and
a determination unit that decides, under a predetermined condition, a ratio between the observation signal and an enhancement signal generated by the voice enhancement using the output value acquired by the acquisition unit, to determine an input signal to be used for the voice recognition.

8. (canceled)

9. The voice signal processing device according to claim 7, wherein the predetermined condition is defined by the following expression when the output value is \hat{ }k, the enhancement signal is \hat{ }S, the observation signal is Y, the input signal is ˜S, and λ is a preset value in a range of 0<λ<1.
$$[ Math . 15 ]$$
$$\hat{k} ∈ [ 0 , 1 ] ,$$
$$[ Math . 16 ]$$
$$\tilde{S} = \{ \begin{matrix}\hat{S} & ( \hat{k} > λ ) \\ Y & ( \hat{k} \leq λ )\end{matrix}$$

10. The voice signal processing device according to claim 7, wherein the predetermined condition is defined by the following expression when the output value is \hat{ }k, the enhancement signal is \hat{ }S, the observation signal is Y, and the input signal is ˜S.
$$[ Math . 17 ]$$
$$\tilde{S} = \hat{k} \cdot \hat{S} + ( 1 - \hat{k} ) \cdot Y$$

11. The voice signal processing method according to claim 7, wherein the output value is an output value output by a learned model, and the learned model receives, as an input, at least one of the observation signal and the enhancement signal, and outputs whether to perform the voice enhancement from a viewpoint of voice recognition performance or the degree of necessity of performing the voice enhancement.

12. The voice signal processing device according to claim 11, wherein the learned model is learned to minimize L, which is a calculation result defined by the following expression, when a loss coefficient is L and a training label used to generate the learned model is k.
$$[ Math . 18 ]$$
$$L = - ( k log ( \hat{k} ) + ( 1 - k ) log ( 1 - \hat{k} ) )$$

13. The voice signal processing device according to claim 12, wherein, in the observation signal, when a true value of a ratio between the voice of the target speaker and the voice of the another speaker is SIR, a true value of a ratio between the voice of the target speaker and the noise is SNR, an output value of the learned model when the SIR is input is \hat{ }SIR, and an output value of the learned model when the SNR is input is \hat{ }SNR, Lₘᵤₗₜᵢ that is a calculation result defined by the following expression is used as the loss coefficient by using parameters α and β.
$$[ Math . 19 ]$$
$${L}_{SIR} = {( - SIR )}^{2} ,$$
$$[ Math . 20 ]$$
$${L}_{SNR} = {( - S N R )}^{2}$$
$$[ Math . 21 ]$$
$${L}_{multi} = L + α {L}_{SIR} + β {L}_{SNR}$$

14. A computer-readable non-transitory recording medium storing computer-executable program instructions that when executed by a processor cause a computer to execute a voice signal processing program generation method comprising:
acquiring an output value indicating whether to perform voice enhancement on an observation signal in which a voice or noise of another speaker overlaps with a voice of a target speaker, or indicating a degree of necessity of performing the voice enhancement; and
deciding, under a predetermined condition, a ratio between the observation signal and an enhancement signal generated by the voice enhancement using the output value that has been acquired, to determine an input signal to be used for voice recognition.

15. The voice signal processing program according to claim 14, wherein the predetermined condition is defined by the following expression when the output value is \hat{ }k, the enhancement signal is \hat{ }S, the observation signal is Y, the input signal is ˜S, and λ is a preset value in a range of 0<λ<1.
$$[ Math . 15 ]$$
$$\hat{k} ∈ [ 0 , 1 ] ,$$
$$[ Math . 16 ]$$
$$\tilde{S} = \{ \begin{matrix}\hat{S} & ( \hat{k} > λ ) \\ Y & ( \hat{k} \leq λ )\end{matrix}$$

16. The voice signal processing program according to claim 14, wherein the predetermined condition is defined by the following expression when the output value is \hat{ }k, the enhancement signal is \hat{ }S, the observation signal is Y, and the input signal is ˜S.
$$[ Math . 17 ]$$
$$\tilde{S} = \hat{k} \cdot \hat{S} + ( 1 - \hat{k} ) \cdot Y$$

17. The voice signal processing program according to claim 14, wherein the output value is an output value output by a learned model, and the learned model receives, as an input, at least one of the observation signal and the enhancement signal, and outputs whether to perform the voice enhancement from a viewpoint of voice recognition performance or the degree of necessity of performing the voice enhancement.

18. The voice signal processing program according to claim 14, wherein the learned model is learned to minimize L, which is a calculation result defined by the following expression, when a loss coefficient is L and a training label used to generate the learned model is k.
$$[ Math . 18 ]$$
$$L = - ( k log ( \hat{k} ) + ( 1 - k ) log ( 1 - \hat{k} ) )$$

19. The voice signal processing program according to claim 18, wherein, in the observation signal, when a true value of a ratio between the voice of the target speaker and the voice of the another speaker is SIR, a true value of a ratio between the voice of the target speaker and the noise is SNR, an output value of the learned model when the SIR is input is \hat{ }SIR, and an output value of the learned model when the SNR is input is \hat{ }SNR, Lₘᵤₗₜᵢ that is a calculation result defined by the following expression is used as the loss coefficient by using parameters α and β.
$$[ Math . 19 ]$$
$${L}_{SIR} = {( - SIR )}^{2} ,$$
$$[ Math . 20 ]$$
$${L}_{SNR} = {( - S N R )}^{2}$$
$$[ Math . 21 ]$$
$${L}_{multi} = L + α {L}_{SIR} + β {L}_{SNR}$$

20. The voice signal processing method according to claim 1, further comprising a switching model unit, in which the switching model unit performs speech recognition by using emphasized signal and observed signal, wherein degradation due to speech enhancement is prevented.

21. The voice signal processing method according to claim 20, wherein the emphasized signal and the observed signal are switched based on determining whether the speech enhancement is required.
